(19) United States
(12) Patent Application Publication
(10) Pub. No.: US 2026/0219293 A1
(43) Pub. Date: Jul. 30, 2026

(54) Active Sensor With a Truck-Specific Housing

(71) Applicant: KNORR-BREMSE Systeme fuer Nutzfahrzeuge GmbH, Muenchen (DE)

(72) Inventors: Christian HUBER, Muenchen (DE); Amadeus MLYNARSKI, Muenchen (DE); Klaus LECHNER, Pretzfeld (DE); Thomas FEUCHT, Wimsheim (DE); Andreas SESSELMANN, Miesbach (DE); Patrick BOLLIG, Muehlacker (DE)

(21) Appl. No.: 19/151,709

(22) PCT Filed: Dec. 21, 2023
(86) PCT No.: PCT/EP2023/087420

§ 371 Date: Jul. 29, 2025

(30) Foreign Application Priority Data
Jan. 30, 2023 (DE) 10 2023 102 100.1

(51) Int. Cl. G01P 1/02

(52) U.S. Cl. CPC G01P 1/026

(57) ABSTRACT

A sensor device for a commercial vehicle, in particular a speed sensor, has a chip with a sensor, which is provided in a housing. The chip is arranged in a watertight manner with respect to the environment, and no metal is provided between the chip and the object to be sensed. Interfering eddy currents can be avoided and a long service life of the sensor can be achieved by the water-tightness.

### BACKGROUND AND SUMMARY

The present application relates to a sensor in a truck-specific housing, in particular an active speed sensor.

Wheel speed sensors are used in commercial vehicles, in particular for anti-lock braking systems (ABS), electronic braking systems (EBS), electronic stability programs (ESP) and autonomous driving.

In the case of the anti-lock braking system (ABS), for example, the speed of the individual vehicle wheels is captured. Especially in commercial vehicles, there are passive, i.e. coil-based, speed sensors which have no further functions. In a truck, passive speed sensors are fastened by means of a clamping sleeve. However, in the automobile sector, in particular, there are also so-called active speed sensors (based on Hall technology or MR technology). These sensors are installed in the direction of a pole wheel or encoder wheel.

Active speed sensors have some advantages because they can have a plurality of functions integrated into them. Such sensors must also be installed accordingly or fixed at their place of use.

For example, the document DE 10 2004 028 818 A1 is known in the prior art. This document discloses a speed sensor having a housing which can be inserted into a holder, wherein the sensor is arranged inside the housing. Contact elements connected to the sensor connect the sensor to an outer side of the housing. The housing can be inserted into the holder accordingly.

In a commercial vehicle, different line paths are required compared to an automobile, since a commercial vehicle is usually much larger. Special precautions must therefore be taken with regard to EMC (electromagnetic compatibility).

It is therefore an object of the present invention to provide a speed sensor which is axially displaceable and which has a high robustness with respect to electromagnetic compatibility. This object is achieved by a sensor device in accordance with the independent claim(s). The dependent claims relate to further advantageous embodiments of the present invention.

A sensor device according to the invention comprises: a chip having a sensor which is provided in a housing, wherein the chip is arranged so as to be watertight with respect to the environment, and no metal is provided between the chip and the object to be sensed.

This provides extreme mechanical robustness and also makes it possible to guarantee maximum robustness with respect to electromagnetic compatibility, since there is no interfering metal near the chip (or in the direct path between the sensor and the object to be sensed). Damage to the chip can also be avoided.

Preferably, the chip is a Hall element, further preferably a 2D/3D Hall element, an R sensor, a GMR sensor or a TMR sensor, which is preferably in the form of a speed sensor.

Such sensors are used particularly in commercial vehicles. Further preferably, a chip comprises at least two active sensing areas. Three active sensing areas can also be provided if, for example, the rotational speed and direction of rotation are intended to be detected.

The housing can be formed from metal. It may include ceramic materials or compound materials.

Preferably, the housing has a cylindrical shape, a prism shape or a cuboid shape, and the chip is arranged near an end face of the housing. Provided in the end face is a bore, the extent of which further preferably corresponds at least to the extent of the chip. This ensures that there is no metal between the chip and the object to be sensed (for example a pole wheel or encoder wheel) that could interfere here with the electromagnetic capture.

This is intended to ensure that there is no metal between active sensing areas of the chip and the object to be sensed.

Further preferably, the housing is tubular-here the end faces are omitted, and here too there is no metal between the chip and the object to be sensed (for example a pole wheel or encoder wheel). The production costs of a tube (only tubular casing) are also significantly lower than those of a sleeve. The electromagnetic compatibility can also be improved since eddy currents can be reduced in the area of the sensor chip.

Preferably, a collar is provided on the end face of the housing, near which the chip is arranged, and extends in the direction of the central axis of the housing, wherein at least one hole is preferably provided in the collar. This hole is used to allow water to accordingly drain out of the housing, if it accumulates there, on the inside of the housing, and not reach the chip.

Further preferably, the chip is provided on a fixing section of a chip carrier, and the chip carrier is arranged within the housing. The chip carrier further preferably comprises a first retaining section and a second retaining section, wherein the first retaining section is opposite a first opening in the housing, and the second retaining section is opposite a second opening in the housing. The retaining sections can thus be held in place with appropriate stamps (retaining devices from the outside for an overmolding process).

Further preferably, the housing is filled with a polymer matrix which surrounds the chip carrier. This allows the chip carrier to be retained in the housing, if the stamps are present, and then allows the overmolding to be carried out.

Further preferably, the chip carrier has a plurality of ribs which are adapted to bear tightly on the inside of the housing. Such ribs may also be in the form of melt ribs which fix the chip carrier to the housing and seal it such that no water can move within the housing and in particular cannot enter the area in which the chip is provided.

In a further embodiment, the housing consists of a thermoset material which completely surrounds the chip, and preferably also the chip carrier. In such an embodiment, there is no longer any need for a sleeve or a tube, which outwardly delimit the sensor device.

Preferably, the sensor device is axially displaceable with respect to the object to be sensed.

This has an advantage, inter alia, when capturing the speed of individual vehicle wheels.

Preferably, the sensor device is used in a commercial vehicle.

Preferred embodiments of the present invention are described in more detail below with reference to the accompanying figures.

### BRIEF DESCRIPTION OF THE DRAWINGS

FIGS. 1a-b show a sensor device according to the prior art, where FIG. 1a) is a sectional view and FIG. 1 b) is an isometric view.

FIGS. 2a-e show a first embodiment according to the present invention. FIG. 2 a) is a sectional view here. FIG. 2 b) and 2 c) are detailed views of a side of the sensor device, FIG. 2 d)is an isometric view of the sensor device, and FIG. 2 e) is a view of the sensor device from the front.

FIG. 3 shows a second embodiment of the sensor device according to the invention in a sectional view. FIGS. 4a-b show a third embodiment of the present invention. Here, FIG. 4 a) is a sectional view, and FIG. 4 b) is an isometric view.

FIGS. 5a-c show a detailed view during the production of the sensor device (according to the first, second or third embodiment), in particular during the overmolding of the chip carrier with a matrix. FIG. 5 b) and 5 c) are corresponding partial views of the corresponding first retaining section and second retaining section.

FIGS. 6a-b show a fourth embodiment of the present invention. FIG. 6 a) shows the chip carrier in particular. FIG. 6 b) is a corresponding isometric view.

FIGS. 7a-b show a fifth embodiment of the present invention. FIG. 7 a) is an isometric view, and FIG. 7 b) is a view from the front.

### DETAILED DESCRIPTION OF THE DRAWINGS

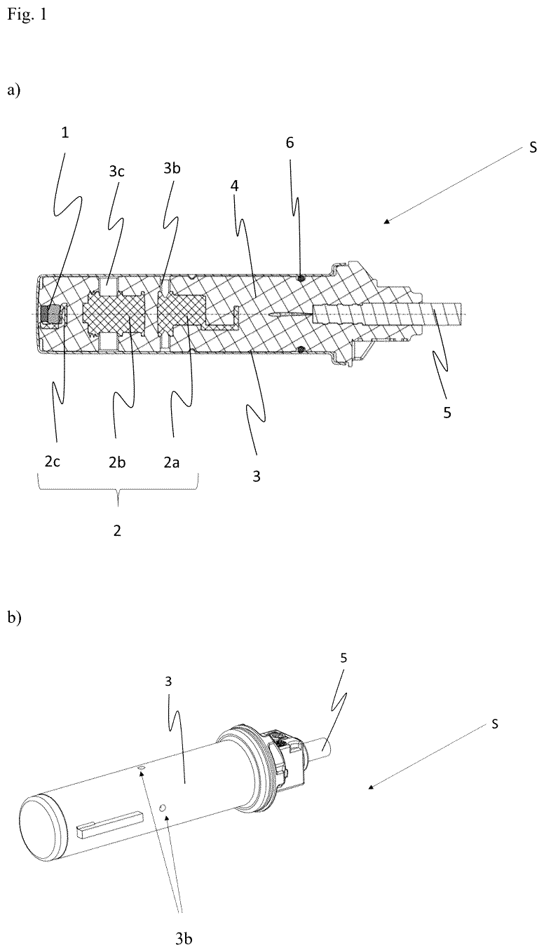

FIG. 1 a) shows a sensor device S according to the prior art in a sectional view. A chip 1 is provided on a chip carrier 2, more precisely on a chip fixing section 2c. The chip carrier 2 further comprises a first retaining section 2a and a second retaining section 2b. The chip carrier 2, including the chip 1, is provided in a housing 3 which is in the form of a sleeve here—i.e. there is a cylindrical shape with a corresponding casing and cover. Furthermore, a seal 6 is provided on the outer side of the housing 3. A cable 5, which connects the housing 3 to the environment, is provided on the side facing away from the chip 1. The chip carrier 2 is fixed within the housing 3, which is overmolded with a polymer matrix 4. A first opening 3b is provided in the housing 3 opposite the first retaining section 2a, and correspondingly a second opening 3c is provided in the housing opposite the second retaining section 2b.

FIG. 1 b) shows an isometric view of a sensor device S according to the prior art. Here it becomes clear that the cable 5 leaves the housing 3, and also first openings 3b are provided here in the housing. The second openings 3c are not shown here.

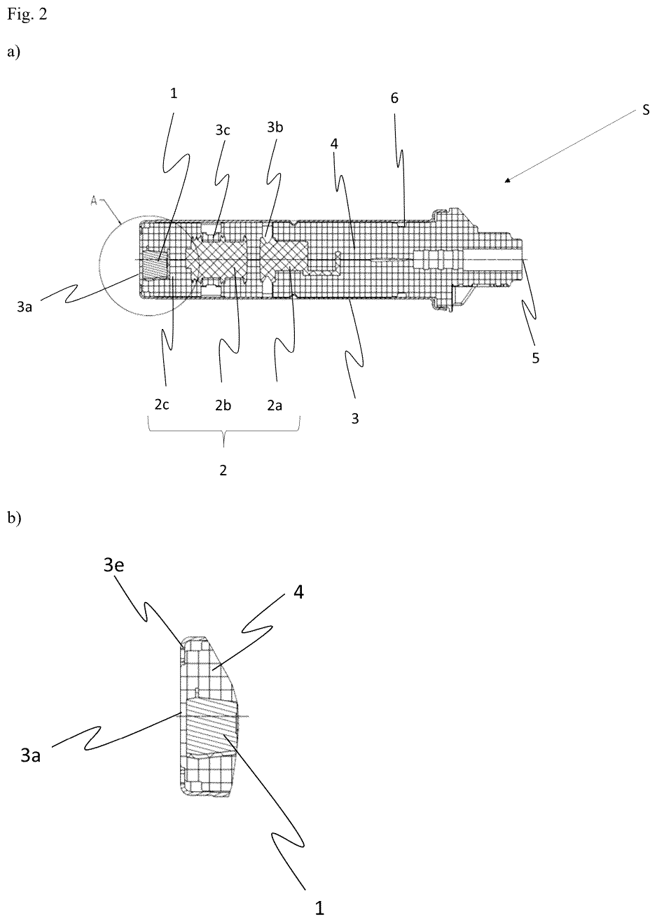

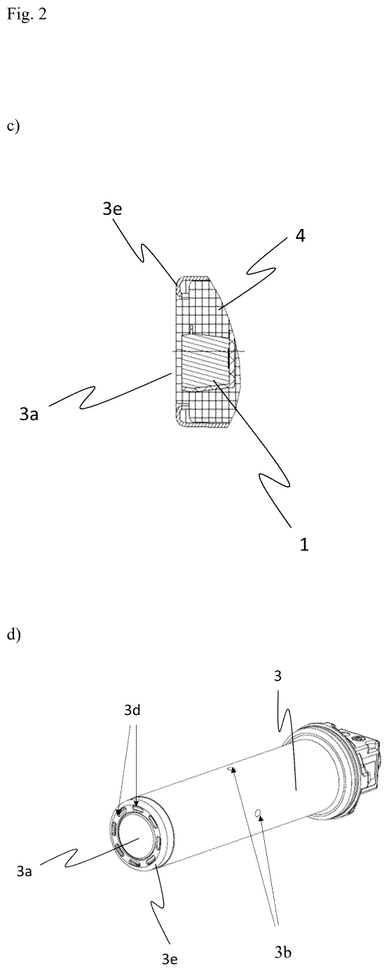

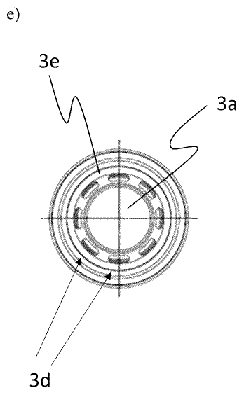

FIG. 2 a) shows a view similar to FIG. 1, but in this case according to a first embodiment of the present invention. Here it is clear that a large bore 3a is provided on the end face of the housing 3, such that there is no metal between the area, over which the chip 1 extends, and an object O to be sensed (not shown here). All other sections here are exactly the same as in FIG. 1 a).

FIG. 2 b) shows a detailed view; the bore 3a is also disclosed here. Furthermore, a corresponding collar 3e is provided here and extends slightly in the direction of the central axis of the housing 3. Here this collar has an L-shape. FIG. 2 c) also shows a collar 3e, but this has a U-shape here. FIG. 2 d) shows a symmetrical view; here again the housing 3 and the first openings 3b are shown. The bore 3a is clearly visible here on the end face, and some holes 3d are provided on the collar 3e. These serve to ensure that, if liquid reaches the interior of the housing 3, it can then easily flow out again. At the same time, however, it is ensured, here by the polymer matrix 4 (not shown here), that the chip is sealed in an absolutely watertight manner from the environment. FIG. 2 e) shows a view from the front; the opening 3a with the corresponding holes 3d in the collar 3e is also shown here.

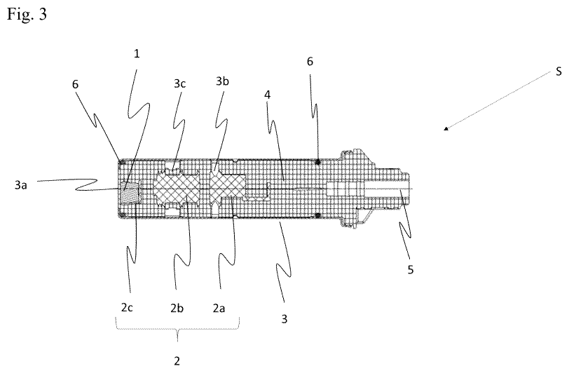

FIG. 3 shows a second embodiment of the present invention. This view is similar to that in FIG. 2 a), with the difference that two seals 6 are also arranged here on the outer side of the housing 3—one on each side of the housing 3. Here, too, there is a sleeve shape, i.e. the cylinder casing and the cover.

FIG. 4 a) shows a third embodiment of the present invention. It is shown here that the housing 3 is in the form of a tube-it therefore has no end surface and no cover, but only a lateral surface. It again becomes clear here that the first retaining section 2a and the second retaining section 2b of a corresponding first opening 3b and a corresponding second opening 3c are opposite the housing 3.

FIG. 4 b) shows an isometric view of the third embodiment, here again the housing 3 with corresponding first openings 3b.

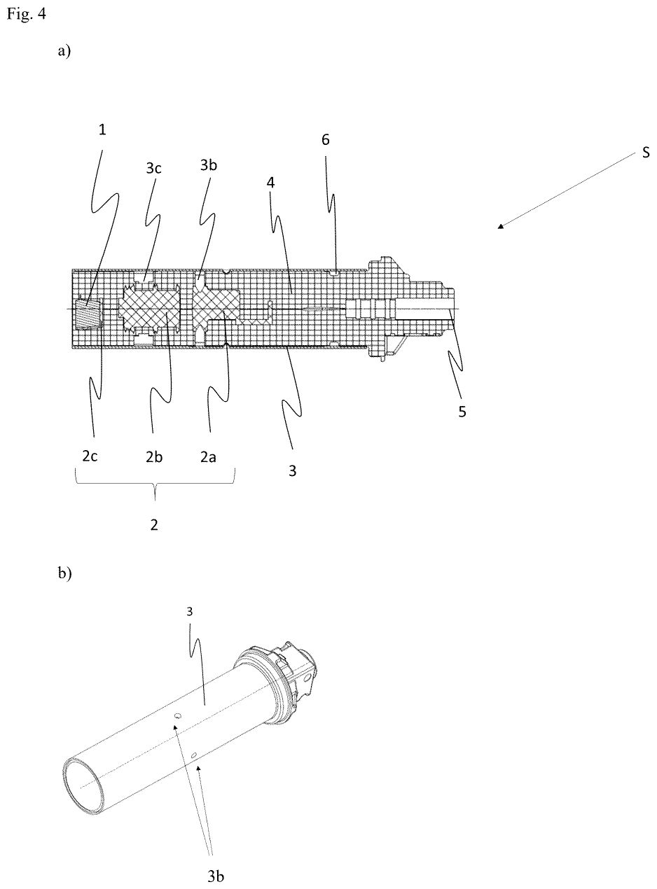

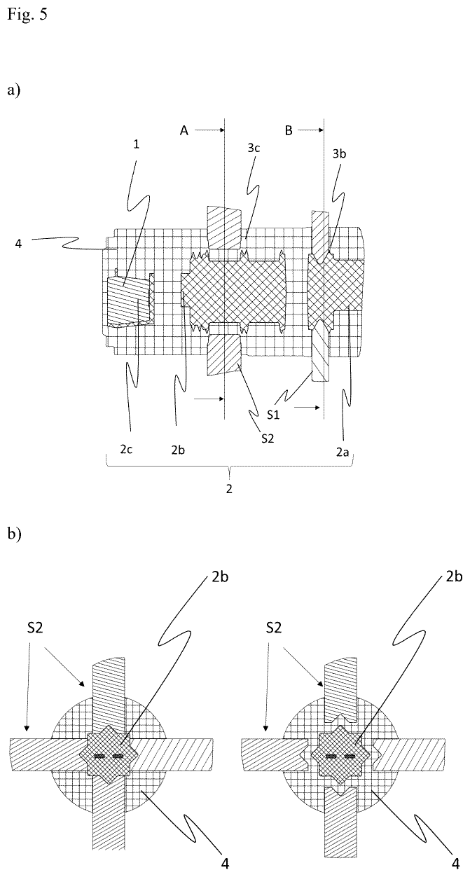

FIG. 5 a) shows a state during the process of producing the sensor device; here it is disclosed in particular that a first stamp S1 can be inserted through the first opening 3b, and a second stamp S2 can be inserted through the second opening 3c. These accordingly retain the chip carrier 2 (the first stamp S1 retains the first retaining section 2a, and the second stamp S2 retains the second retaining section 2b), while the overmolding with the polymer matrix 4 takes place.

FIG. 5 b) shows two states during the overmolding process indicating how the second retaining section 2b is accordingly retained from a plurality of sides by the second stamp S2. The left-hand view shows that the stamps S1 fix a star-shaped section of the second retaining section 2b, and then the corresponding area is omitted from the polymer matrix. The right-hand illustration shows a later state; here the second stamps S2 have moved slightly away from the second retaining section 2b, such that the direct environment of the second retaining section 2b is overmolded. It is thus ensured that there is no hole within the polymer matrix 4, but rather that the polymer matrix 4 seals the chip element 1 (not shown here) in a completely watertight manner with respect to the environment.

FIG. 5 c) shows how the first retaining section 2a is accordingly retained by first stamps S1. Here, no two-stage overmolding is carried out, as shown in FIG. 5 b). Here, holes can indeed arise, but these are far away from the sensor element 1, as is clear from FIG. 5 a).

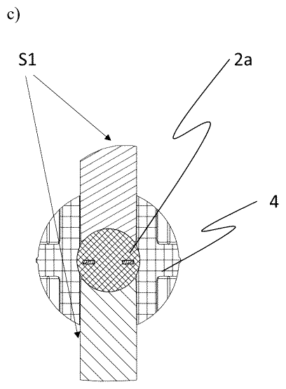

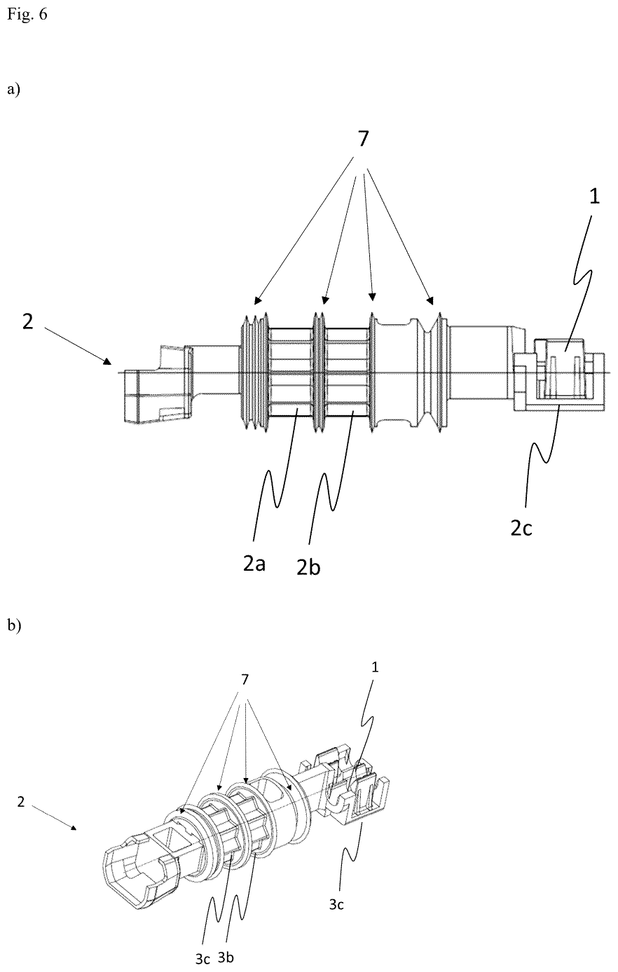

FIG. 6 a) shows a fourth embodiment of the present invention. Only one chip carrier 2 is shown here, correspondingly again with a first retaining section 2a and a second retaining section 2b.

A plurality of ribs 7 are provided along the chip carrier 2 and can be in the form of, for example, melt ribs (which melt when heated, for example, and thus achieve a sealing effect). These can seal the chip carrier 2 in an accordingly watertight manner with respect to the housing 3 (not shown here), such that no water enters in the direction of the chip 1 (accordingly at the chip fixing section 2c).

FIG. 6 b) shows a corresponding isometric view of the chip carrier 2 according to the fourth embodiment.

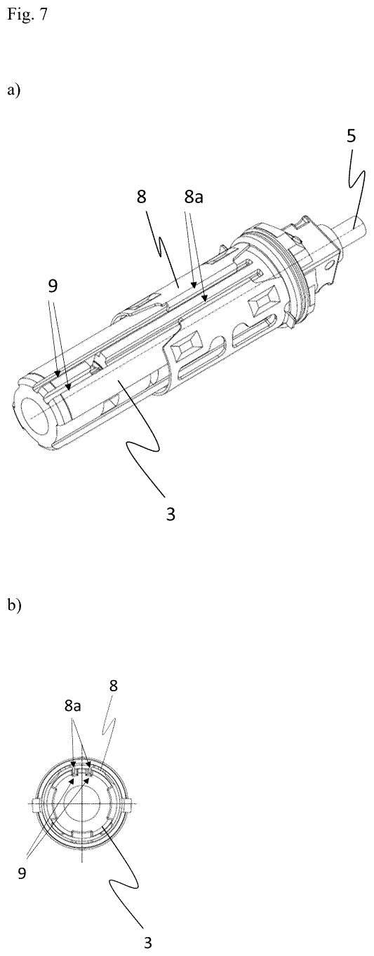

FIG. 7 a) shows a fifth embodiment of the present invention in an isometric view. Here again a housing 3 is provided, and a cable 5 leaves this accordingly. Here, however, the chip 1 and the chip carrier 2 (not shown here) are completely surrounded by a thermoset housing 3, i.e. the chip 1 and the chip carrier 2 (not shown here) are correspondingly overmolded with a thermoset. The housing 3 contains two recesses 9, in which corresponding engagement sections 8 of a clamping sleeve can engage, which make the housing correspondingly more robust. FIG. 7 b) shows a view from the front; here again the position of the two engagement sections 8a of the clamping sleeve 8 in a corresponding recess 9 is shown more precisely.

The present invention is not restricted to the aforementioned embodiments.

Overmolding can also take place with other materials, such as gum, rubber or other waterproofing materials.

### LIST OF REFERENCE SIGNS

S Sensor device
1 Chip
2 Chip carrier
2a First retaining section
2b Second retaining section
2c Chip fixing section
3 Housing
3a Bore
3b First opening
3c Second opening
3d Hole
3e Collar
4 Polymer matrix
5 Cable
6 Seal
7 Rib
8 Clamping sleeve
8a Engagement section
9 Recess
S1 First stamp
S2 Second stamp
O Object

1.-12. (canceled)

13. A sensor device, comprising:
a housing;
a chip having a sensor which is provided in the housing,
wherein the chip is arranged so as to be watertight with respect to an environment of the sensor device, and
wherein no metal is provided between the chip and an object to be sensed.

14. The sensor device as claimed in claim 13, wherein
the chip is one of: a Hall element, an MR sensor, a GMR sensor, or a TMR sensor, and
the chip further comprises at least two active sensing areas.

15. The sensor device as claimed in claim 14, wherein
the Hall element is a 2D or 3D Hall element.

16. The sensor device as claimed in claim 14, wherein the sensor is a speed sensor.

17. The sensor device as claimed in claim 13, wherein
the housing has a cylindrical shape, a prism shape or a cuboid shape, and
the chip is arranged near an end face of the housing, in which a bore is provided, an extent of said bore corresponding at least to an extent of the chip.

18. The sensor device as claimed in claim 13, wherein the housing is tubular.

19. The sensor device as claimed in claim 18, wherein
a collar is provided on an end face of the tubular housing, near which the chip is arranged, and extends in a direction of a central axis of the tubular housing, and
at least one hole is provided in the collar.

20. The sensor device as claimed in claim 13, wherein
the chip is provided on a chip fixing section of a chip carrier, and
the chip carrier is arranged within the housing.

21. The sensor device as claimed in claim 20, wherein
the chip carrier further has a first retaining section and a second retaining section,
the first retaining section is opposite a first opening in the housing, and
the second retaining section is opposite a second opening in the housing.

22. The sensor device as claimed in claim 20, wherein the housing is filled with a polymer matrix which surrounds the chip carrier.

23. The sensor device as claimed in claim 20, wherein
the chip carrier further has a plurality of ribs which are adapted to bear tightly on an inner side of the housing.

24. The sensor device as claimed in claim 20, wherein
the housing consists of a thermoset material which completely surrounds the chip and the chip carrier.

25. The sensor device as claimed in claim 13, wherein the sensor device is axially displaceable with respect to the object to be sensed.

26. A method of operating a commercial vehicle utilizing the sensor device as claimed in claim 13.
